(19) United States
(12) Patent Application Publication
(10) Pub. No.: US 2010/0165881 A1
(43) Pub. Date: Jul. 1, 2010

(54) METHOD FOR SETTING UP A LOGIC CONNECTING PATH IN A CONNECTION-ORIENTED PACKET-SWITCHED COMMUNICATION NETWORK

(76) Inventors: Axel Hof, Olching (Esting) (DE); Johannes Riedl, Ergolding (DE)

Correspondence Address: STAAS & HALSEY LLP, SUITE 700, 1201 NEW YORK AVENUE, N.W., WASHINGTON, DC, 20005, US

(21) Appl. No.: 12/600,463

(22) PCT Filed: Apr. 28, 2008
(86) PCT No.: PCT/EP08/55190

§ 371 Date: Nov. 16, 2009

(30) Foreign Application Priority Data
May 15, 2007 (DE) 10 2007 022 704.5

(51) Int. Cl. H04L 12/28; H04L 12/66

(52) U.S. Cl. 370/254; 370/352

(57) ABSTRACT

The subject matter relates to a method for setting up a logic end-to-end connecting path of a selectable first bandwidth from a starting nodal point to a target nodal point in a connection-oriented packet-switched communication network, including: determining a plurality of physical end-to-end data transmission paths from the starting nodal point to the target nodal point having second bandwidths corresponding to the logic connecting path to be set up; selecting one or more of the determined physical data transmission paths such that the second bandwidth of the physical data transmission paths in sum corresponds at least to the first bandwidth of the logic connecting path; and signaling the at least one selected physical data transmission path for setting up the logic connecting path.

### CROSS REFERENCE TO RELATED APPLICATIONS

This application U.S. National State of International Application No. PCT/EP2008/055190, filed Apr. 28, 2008 and claims the benefit thereof. The International Application claims the benefits of German Application No. 102007022704.5 filed on May 15, 2007, both applications are incorporated by reference herein in their entirety.

### BACKGROUND

The subject matter of this disclosure lies in the technical field of communications networks and relates to a method for setting up a logical connection path between a source network node and a destination network node in a connection-oriented communications network using packet switching. The subject matter further relates to a method, based on the method for setting up a logical connection path, for transmitting data packets between a source network node and a destination network node of a connection-oriented packet-switched communications network. Furthermore it relates to a connection-oriented packet-switched communications network that is suitable for performing the method.

In connection-oriented communications networks, a permanent data transmission path is set up between a source and a destination network node before a transmission of data takes place. A significant advantage here lies in the controllable behavior of the network, since resources can be reserved for the data transmission paths. It is, however, disadvantageous that data transmission paths are also held in readiness even when no data is transmitted.

In packet-switched communications networks, no data transmission path is set up, but instead the data packets that are to be transmitted between a source and a destination network node are provided with the address of the destination network node and on the basis of the address are routed to the destination network node over a “shortest path” calculated by means of a suitable algorithm (“hop-by-hop routing”). In packet-switched networks the data packets that are to be transmitted to the same destination network node always take the same data transmission path between source and destination network node, so data congestion can result if the bandwidth of the data transmission path is not sufficient to satisfy the requirements.

In order to exploit the advantages of a connection-oriented transmission in packet-switched communications networks it is known in modern communications networks to employ hybrid data transmission methods which represent a combination of the connection-oriented and the packet-switched data transmission methods.

An example of such a connection-oriented packet-switched data transmission method is MPLS (MPLS=Multiprotocol Label Switching). In accordance with the principle of connection switching, MPLS is based on the mechanism that data packets within an autonomous MPLS network are no longer transmitted from a source network node to a destination network node on the basis of the destination address, but rather that a virtual end-to-end data transmission path (“tunnel”) with possibly reserved bandwidth is set up dynamically (“signaled”) between source and destination network node and the data packets are then sent via the path. On completion of the data transfer the data transmission path can be cleared again.

Upon entering the MPLS network the data packets are for that purpose provided with a special MPLS header (“shim header”) which is inserted between the layer 2 header and the layer 3 header (OSI model). The MPLS header contains a special identifier (label) on the basis of which the data packet is routed through the network. The labels are determined by means of parameters, such as MAC address, IP address, ports of source network node and destination network node, data rate, delay, and jitter. An assignment of the data packets to labels takes place within logical classes, called Forwarding Equivalence Classes (FECs), the FECs defining, in particular, which quality of service is assigned to a data packet. During this process, it is also possible to assign data packets with the same destination network node to different FECs, with the result that the data packets can be transferred to the destination network node over different transmission paths. At the egress of the MPLS network the labels are removed from the data packets again.

Thus, within the MPLS network the hop-by-hop routing used in packet switching is restored to a (high-speed) switching scheme along predefinable data transmission paths. In particular, the possibility of selecting data transmission paths enables data congestion to be avoided and quality-of-service requirements to be fulfilled to a certain degree.

In MPLS data packets are transferred over a logical end-to-end connection path between source and destination network node (LER=Label Edge Router) which is implemented by means of a dynamically set-up physical end-to-end data transmission path (“tunnel”). The network nodes located between source and destination network node are referred to as LSRs (LSR=Label Switch Router). A tunnel is a physical end-to-end data transmission path that is built up from physical point-to-point data links for the purpose of transmitting data between source and destination network node and is uniquely defined by a sequence of labels.

In this scenario, a least-cost path between the LERs is initially calculated in a first step by means of a suitable routing algorithm, such as CSPF (CSPF=Constraint Shortest Path First) for example, with connection and network node characteristics such as bandwidth (bit rate), delay and jitter also being taken into account in addition to the path costs. Thus, CSPF first identifies all paths with lowest costs between the two LERs, from these identified paths those paths having the highest bandwidth are identified, from these identified paths those paths having the lowest hop count, i.e. the smallest number of LSRs between the two LERs are identified, and subsequently a path is selected at random from the remaining paths.

An exchange of messages between the network nodes is ensured via IGPs (IGP=Interior Gateway Protocol) implemented in the routing algorithm, such as IS-IS (IS-IS=Intermediate System to Intermediate System Protocol) or OSPF (OSPF=Open Shortest Path First), such that the network nodes can “see” each other and are kept constantly informed about the transmission characteristics, in particular the bandwidths available in the network.

Next, in a second step, a message PATH is sent using a suitable signaling protocol from the ingress-side LER to the neighboring LSR in the identified data transmission path, supplemented with a so-called LABEL-REQUEST by the LSR and sent to the next network node on the data transmission path. This process is repeated until the message has reached the egress-side LER.

The egress-side LER reads the message PATH and in a third step initiates a reservation of the resources by assigning a label, generating a message RESV and sending the latter over the same data transmission path in the reverse direction to its immediately neighboring network node (LSR). The network node reads the message RESV, stores the label assigned by the egress-side LER in its forwarding table, selects another label, replaces the existing label in the RESV with the new label and sends a modified message RESV to the next network node on the transmission path in the direction of the ingress-side LER. This process is repeated until the message RESV reaches the ingress-side LER, as a result of which a sequence of labels is generated for a specific transmission path having specific transmission characteristics (FEC).

Thus, a label is agreed between each pair of neighboring network nodes within a previously identified data transmission path with the aid of the signaling protocol in such a way that neighboring network nodes in each case hold an identical label value in their forwarding tables. In this way an identical label value defines a virtual point-to-point data link between the ports of two neighboring network nodes within the virtual data transmission path.

The most commonly used signaling protocol is RSVP-TE (RSVP-TE=Resource Reservation Protocol for Traffic Engineering), a protocol which offers in particular the options of reserving resources and controlling data streams on the basis of the label assignment.

When the ingress-side LER receives data packets, the data packets are assigned to specific FECs on the basis of packet properties and identified by a label (“Push”). All data packets belonging to the same FEC are in this case identified by means of the same label. The data packets are then sent to the next network node on the data transmission path. The receiving network node identifies the data packets belonging to an FEC on the basis of the labels, changes the labels by means of the forwarding table (“Swap”) and sends the data packets to its corresponding egress port. This is repeated in the transmission path until the data packets have reached the egress-side LER, where the labels are removed again (“Pop”). A tunnel for transmitting the data packets assigned to an FEC is uniquely defined by means of the sequence of labels (“concatenation”) assigned to a specific FEC. The assignment of the labels to specific FECs specifies the transmission characteristics for a specific transmission path.

A significant advantage of the hybrid data transmission methods, illustrated by way of example on the basis of MPLS, lies in the possibility of the targeted choice of a data transmission path for the data traffic in the network, such that in particular broadband data paths with minimal delay can be made available for a data transmission. It is disadvantageous, however, that when a bandwidth request is received at the source network node a corresponding physical data transmission path can only be set up in the network when the bandwidth request can actually be fulfilled on the basis of the bandwidths present in the network. If the bandwidth request cannot be fulfilled, because, for example, bandwidths are already reserved for other physical data transmission paths, no physical data transmission path is set up and an error message is output to that effect. Since the bandwidths made available by the network become less as data traffic increases in the network, the probability that a bandwidth request cannot be fulfilled in the network increases as data volumes increase, with the result that under certain conditions it may not be possible to maintain a promised quality of service (QoS).

### SUMMARY

Accordingly an aspect of the present subject matter involves providing a method for setting up a logical connection path between a source network node and a destination network node in a connection-oriented packet-switched communications network by means of which the above-cited disadvantages can be avoided.

This object is achieved according to the subject matter of the disclosure by a method for setting up a logical connection path between a source network node and a destination network node in a connection-oriented packet-switched communications network.

According to the subject matter of the disclosure, a method is disclosed for setting up a logical end-to-end connection path having a selectable first bandwidth from a source network node to a destination network node in a connection-oriented packet-switched communications network. As explained in the introduction, the communications network is a network in which data is transferred using a hybrid data transmission method which represents a combination of a connection-oriented and a packet-switched data transmission method. With the aid of the data transmission method, (virtual) physical end-to-end data transmission paths for the purpose of transferring data from the source network node to the destination network node are set up dynamically to implement the logical end-to-end connection path, before a transfer of data packets from a source network node to a destination network node takes place, which data transmission paths can be cleared down again upon completion of the data transfer. The hybrid data transmission method for controlling the data transfer in the communications network can be performed on a decentralized basis in electronic data processing devices of the network nodes, although it is equally possible for the data transmission method to be performed in a centralized network management device that is suitable for electronic data processing and is connected to the network nodes for data communication purposes.

According to the subject matter of the disclosure, a logical end-to-end connection path having a selectable first bandwidth is set up from a source network node to a destination network node in the connection-oriented packet-switched communications network. A “logical end-to-end connection path” is understood in this context and herein below to mean a connection between source and destination network node which can be realized by means of different physical end-to-end data transmission paths (tunnels) from the source network node to the destination network node which are actually used for transferring the data packets. Accordingly a logical connection path simply specifies the connection of data packets from source network node to the destination network node with a selectable first bandwidth without defining in the process the physical point-to-point data links actually use for transferring the data packets or, as the case may be, the physical end-to-end data transmission paths built up from the physical point-to-point data links. To set up a logical connection path it is therefore necessary to set up (“signal”) at least one physical data transmission path implementing the logical connection path, with respective bandwidths being reserved for the physical point-to-point data links constructing the physical end-to-end data transmission path.

The method according to the subject matter of the disclosure for setting up a logical end-to-end connection path having a selectable first bandwidth from a source network node to a destination network node in a connection-oriented packet-switched communications network comprises the following successive steps discussed below.

On the basis of a request for a logical connection path having a specific selectable (first) bandwidth from a source network node to a destination network node in the connection-oriented packet-switched communications network, a plurality of physical end-to-end data transmission paths (tunnels) from the source network node to the destination network node are first determined with the, in each case, available (second) bandwidths for implementing the logical connection path that is to be set up. The physical end-to-end data transmission paths from the source network node to the destination network node are determined using a suitable routing algorithm, for example on the basis of CSPF (CSPF=Constraint Shortest Path First), which can calculate paths from the source network node to the destination network node while taking into account path costs and bandwidths. A message exchange between the network nodes is ensured by means of an IGP protocol (IGP =Interior Gateway Protocol) implemented in the routing algorithm, such as IS-IS (IS-IS=Intermediate System to Intermediate System Protocol) or OSPF (OSPF=Open Shortest Path First) for example, such that the network nodes can “see” each other and are kept constantly updated on the transmission characteristics, in particular, the bandwidths available in the network. The maximum available bandwidth of a physical end-to-end data transmission path results from the smallest bandwidth of the physical point-to-point data links between each pair of neighboring network nodes that make up the physical end-to-end data transmission path.

Subsequently one or more of the identified physical end-to-end data transmission paths is selected subject to the condition that the sum total of the second bandwidths of the physical data transmission paths is at least as great as the selectable first bandwidth of the logical connection path.

This is followed by a signaling (setting up) of the one or more selected physical data transmission paths, with bandwidths being reserved for the point-to-point data links making up the physical data transmission paths, as a result of which the logical connection path is set up. The data transmission paths are signaled by means of a suitable signaling protocol, such as, for example, RSVP-TE (RSVP-TE=Resource Reservation Protocol for Traffic Engineering). By this approach it is possible to set up virtual physical data transmission paths in the form of Label Switched Paths (LSPs) which can be set up by a concatenated sequence of labels with reserved bandwidths. In this arrangement two neighboring network nodes of the LSP in each case hold a label with an identical value.

Thus, by the method according to the subject matter of the disclosure it is advantageously possible to signal a plurality of physical data transmission paths (tunnels) from the source network node to the destination network node for one and the same logical connection path between source and destination network node thereby to provide a required bandwidth for transmitting data between source and destination network node, which requirement could not be fulfilled by only one single physical data transmission path. In contrast to the conventional hybrid data transmission methods, such as MPLS, a logical connection path can therefore be set up even when no physical data transmission path fulfills the required bandwidth on its own.

In an advantageous embodiment of the method according to the subject matter of the disclosure the physical data transmission paths are selected successively according to highest available second bandwidth in each case. Thus, the physical data transmission path identified as having the highest bandwidth is chosen first, then the path having the second-highest bandwidth, and so on, until the sum total of the (second) bandwidths of the physical data transmission paths is at least as large as the required first bandwidth of the logical connection paths between source and destination network node. By this means it can advantageously be ensured that a minimum number of physical data transmission paths is signaled for implementing the logical connection path, so that a wasting of resources can be avoided.

In a further advantageous embodiment of the method according to the subject matter of the disclosure the required first bandwidth of the logical connection path is divided by a selectable divider, thereby yielding a third bandwidth as its result. A number of physical data transmission paths corresponding to the result of the divider is then selected, and moreover subject to the condition that their second bandwidths correspond at least to the third bandwidth. By this means the physical data transmission paths can be selected in a particularly simple manner.

The subject matter of the disclosure further relates to a method for transmitting data packets from a source network node to a destination network node in a connection-oriented packet-switched communications network, where, on the basis of a request for a logical connection path from a source network node to a destination network node in the connection-oriented packet-switched communications network, a logical end-to-end connection path from the source network node to the destination network node is first set up in accordance with the above-described method. The data packets that are to be transmitted are then allocated by the source network node to the signaled physical data transmission paths corresponding to the second bandwidths and the data packets are forwarded to the destination network node. The data packets are allocated to the signaled data transmission paths by a load balancing algorithm known per se (scatter algorithm). If the physical data transmission paths are set up in the form of LSPs, for example, the data packets can be allocated by their being provided with a corresponding label. By the method for transmitting data packets from a source network node to a destination network node data packets can advantageously be transmitted to the destination network node over a logical connection path between source and destination network node even when the bandwidth request for transmission of the data packets cannot be fulfilled by any single physical data transmission path on its own.

In an advantageous embodiment of the method for transmitting data packets from a source network node to a destination network node in a connection-oriented packet-switched communications network over a set-up logical connection path the data packets are allocated to the signaled physical data transmission paths by means of a hash algorithm. By this a transposition of data packets can advantageously be avoided.

The subject matter of the disclosure also extends to a connection-oriented packet-switched communications network having a plurality of network nodes that are connected to one another via point-to-point data links and are set up in such a way that they can perform a method as described above.

In addition the subject matter of the disclosure extends to a machine-readable program code for a network node of a connection-oriented packet-switched communications network as described above, which code contains control commands that cause the network node to perform a method as described above.

Furthermore the subject matter of the disclosure extends to a network node of a connection-oriented packet-switched communications network on which a machine-readable program code as described above is executed.

The subject matter of the disclosure also extends to a storage medium on which a machine-readable program code as described above is stored.

### BRIEF DESCRIPTION OF THE DRAWINGS

These and other aspects and advantages will become more apparent and more readily appreciated from the following description of the exemplary embodiments, taken in conjunction with the accompanying drawings of which:

The subject matter of the disclosure will now be explained in more detail with the aid of an exemplary embodiment, with reference being made to the attached drawings, in which:

FIG. 1 schematically shows an exemplary embodiment of the inventive communications network having the bandwidths available on the respective data links; and

FIG. 2 schematically shows the communications network of FIG. 1 with signaled physical data transmission paths for implementing a logical connection path between network node N1 and network node N6.

### DETAILED DESCRIPTION OF THE PREFERRED EMBODIMENTS

Reference will now be made in detail to the preferred embodiments, examples of which are illustrated in the accompanying drawings, wherein like reference numerals refer to like elements throughout.

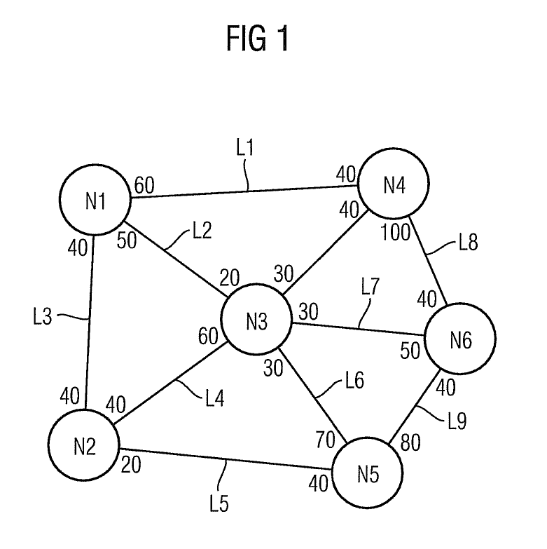

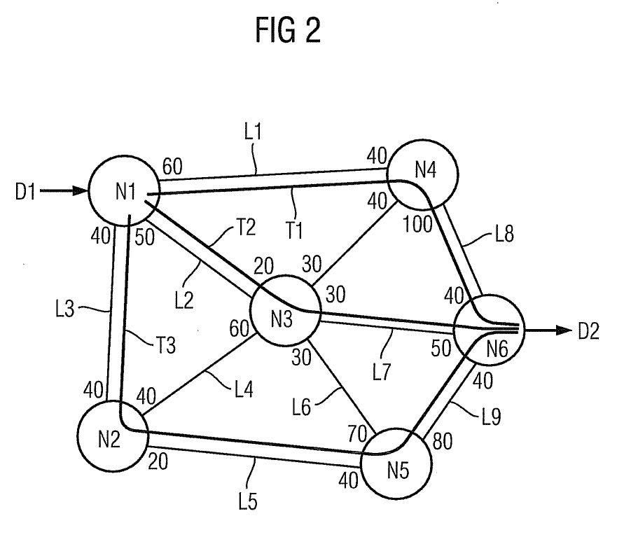

FIGS. 1 and 2 show an exemplary embodiment of the connection-oriented packet-switched communications network according to the subject matter of the disclosure. The autonomous communications network includes a plurality of network nodes (in this instance, by way of example, six) N1-N6 which are connected to one another in a meshed arrangement by way of physical point-to-point data links L1-L9. Also indicated are the bandwidths available at a specific point in time on the outgoing data link of the network nodes N1-N6 in each case.

Thus, for example, the network node N1 is connected for data communication purposes to the network node N4 via a physical data link L1, the network node N1 making a bandwidth of 60 Mbps available for the outgoing data link L1 and the network node N4 making a bandwidth of 40 Mbps available for the outgoing data link L1. The network node N1 is also connected for data communication purposes via a physical data link L2 and a physical data link L3 to the network node N3 and the network node N2, respectively, the network node N1 making a bandwidth of 50 Mbps available in respect of the outgoing data link L2 and a bandwidth of 40 Mbps in respect of the outgoing data link L3. The network node N3 makes a bandwidth of 20 Mbps available for the outgoing data link L2, and the network node N2 provides a bandwidth of 40 Mbps for the outgoing data link L3. All further details relating to the bandwidths in the figures are to be understood analogously.

In the communications network, a hybrid data transmission method is set up in the network nodes N1-N6, by which method virtual physical end-to-end data transmission paths for transferring data from the source network node to the destination network node can be set up dynamically for the purpose of implementing a logical end-to-end connection path before a transmission of data packets from a source network node to a destination network node, and can be cleared down again upon completion of the data transfer.

By signaling one or more physical data transmission paths the data transmission method is able to set up a logical connection path between a source network node and a destination network node.

For that purpose a routing algorithm is implemented in the communications network in the network nodes N1-N6; by the routing algorithm physical end-to-end data transmission paths from the source network node to the destination network node can be determined to implement a logical end-to-end connection path having a specific (selectable) bandwidth between a source network node and a destination network node while taking into account path costs and the available bandwidths of the data links. A routing algorithm of this type is based on CSPF for example. An exchange of messages between the network nodes N1-N6 is ensured by an IGP implemented in the routing algorithm, such as IS-IS or OSPF, for example, such that the network nodes N1-N6 are kept informed at all times about the bandwidths of the data links that are available in the communications network.

The hybrid data transmission method is also able to select one or more of the identified physical end-to-end data transmission paths subject to the condition that the sum total of their bandwidths is at least as great as the bandwidth of the logical connection path.

Also implemented in the network nodes N1-N6 is a signaling protocol in the form of RSVP-TE which supports the setting up (signaling) of a physical data transmission path in the form of a Label Switched Path (LSP) and enables the reservation of bandwidths.

Furthermore the hybrid data transmission method can assign the data packets that are to be transmitted to a logical class (FEC), provide them with a label and allocate them to the signaled LSPs. Toward that end a load balancing algorithm (scatter algorithm), for example, a hash algorithm, is implemented in the data transmission method. The network nodes lying between a source and a destination network node of the same physical data transmission path are able to forward received data packets to the destination network node on the basis of the label. The destination network node can remove the label again.

FIG. 2 illustrates an exemplary embodiment variant of the inventive method for transmitting data packets along a logical connection path realized by a plurality of physical data transmission paths.

As the source network node, network node N1 receives a data stream D1 which is to be transmitted with a bandwidth reservation of 100 Mbps to the network node N6 as destination network node. The object is therefore to set up a logical connection path with a bandwidth of 100 Mbps between the network node N1 and the network node N6.

On the basis of the connection request the network node N1 first identifies possible physical data transmission paths (tunnels) and their bandwidths to implement the logical connection path between the network node N1 and the network node N6. Because of the routing algorithm implemented in the communications network the network node N1 “knows” the topology of the network and the bandwidths of all outgoing data links that are available at this point in time.

In this case the network node N1 identifies, for example, three tunnels T1-T3. The first tunnel T1 includes the virtual data links L1 and L8 and links network node N1 and network node N6 through the intermediary of network node N4. Network node N1 makes a bandwidth of 60 Mbps available for the outgoing data link L1 of the first tunnel T1 and network node N4 makes a bandwidth of 100 Mbps available for the outgoing data link L8 of the first tunnel T1. Accordingly, the first tunnel T1 can provide a maximum bandwidth of 60 Mbps. The second tunnel T2 includes the virtual data links L2 and L7 and links network node N1 and network node N6 through the intermediary of network node N3. Network node N1 makes a bandwidth of 50 Mbps available for the outgoing data link L2 of the second tunnel T2 and network node N3 makes a bandwidth of 30 Mbps available for the outgoing data link L7 of the second tunnel T2. Accordingly, the second tunnel T2 can provide a maximum bandwidth of 30 Mbps. The third tunnel T3 includes the virtual data links L3, L5 and L9 and links network node N1 and network node N6 through the intermediary of the network nodes N2 and N5. Network node N1 makes a bandwidth of 40 Mbps available for the outgoing data link L3 of the third tunnel T3, network node N2 makes a bandwidth of 20 Mbps available for the outgoing data link L5 of the third tunnel T3, and network node N5 makes a bandwidth of 80 Mbps available for the outgoing data link L9 of the third tunnel T3. Accordingly, the third tunnel T3 can provide a maximum bandwidth of 20 Mbps.

Network node N1 registers the maximum available bandwidths of the respectively identified tunnels T1-T3 and recognizes that the bandwidth request for the data stream D1 cannot be realized by a single tunnel, since only a maximum bandwidth reservation of 60 Mbps is possible for tunnel T1.

Network node N1 now selects the identified tunnels on the basis of the maximum available bandwidths subject to the condition that the sum total of the maximum available bandwidths of the selected tunnels corresponds at least to the requested bandwidth of 100 Mbps. In this exemplary embodiment network node N1 selects the identified tunnels successively according to the highest maximum available bandwidth in each case. Thus, tunnel T1, with a maximum available bandwidth of 60 Mbps, is selected first. Network node N1 then realizes that a remaining bandwidth of 40 Mbps still needs to be reserved by means of further tunnels. On the basis of the maximum available bandwidth network node N1 then selects tunnel T2, which has a maximum available bandwidth of 30 Mbps. Network node N1 then realizes that a remaining bandwidth of 10 Mbps still needs to be reserved by means of further tunnels. On the basis of the maximum available bandwidth network node N1 then selects tunnel T3, which has a maximum available bandwidth of 10 Mbps. As a result of the selection of the three tunnels T1-T3, the requested total bandwidth of 100 Mbps can be ensured for the data stream D1.

This is then followed by a signaling of the selected tunnels T1-T3 by the signaling protocol in the form of conventional Label Switched Paths (LSPs) on which the available bandwidths of the data links are reserved in each case.

For the purpose of signaling tunnel T1 the network node N1 sends a message PATH to the neighboring network node N4 over the data link L1. The node adds a LABEL-REQUEST to the message PATH and sends it to the network node N6 via the data link L8. The network node N6 reads the message PATH, assigns a label, generates a message RESV provided with the label and sends the message via the data link L8 to the network node N4. The network node N4 reads the message RESV, stores the label contained therein in its forwarding table, selects a different label, replaces the existing label in the message RESV and sends the modified message RESV to the network node N1. Network node N1 receives the message RESV and stores the label contained therein in its forwarding table. Thus, a virtual data link L1 is uniquely defined by an identical label in each case in the network nodes N1 and N4, and a virtual data link L8 is uniquely defined by an identical label in each case in the network nodes N4 and N6. The first tunnel T1 is defined by the concatenated sequence of labels. The corresponding bandwidths of the data links are reserved. The second tunnel T2 and the third tunnel T3 are signaled in an analogous manner in each case.

The data packets contained in the data stream D1 are allocated by the network node N1 to the different tunnels T1-T3 in accordance with the available maximum bandwidths. Toward that end the data packets received by network node N1 are identified by a label using the push method, with the tunnel to be used for the transmission of the data packet being specified by the choice of label. Inside the respective tunnels the data packets are forwarded using the swap method until they reach the network node N6. The labels are removed from the data packets again in the network node N6. The data streams routed via the three tunnels T1-T3 are merged once again in the network node N6 into a single data stream D2 which, after being forwarded by network node N6, can be transmitted further by hop-by-hop routing, for example.

In the method according to the subject matter of the disclosure, only network node N1 must have “knowledge” about the implementation of the logical connection path by means of the three tunnels T1-T3 and distribute the data load of the data stream D1 in the ratio 6:3:1. Network node N6 needs to have no “knowledge” about the three tunnels T1-T3.

Further features of the subject matter of the disclosure will emerge from the following description:

In the method according to the subject matter of the disclosure, a logical connection path between two end nodes A, B is implemented not by a single tunnel, but by an aggregation of tunnels. If the ingress network node (source network node) detects that the bandwidth requirement “x” of the connection path cannot be fulfilled by a single tunnel, it successively attempts to set up two, three, four or more tunnels with smaller bandwidth. If n tunnels with corresponding bandwidths x₁, . . . , xₙ (where x≦x₁, . . . , xₙ) were set up successfully, the data traffic is allocated accordingly to the n tunnels.

A simple possibility of determining the bandwidths xᵢ is a uniform distribution: xᵢ=x/n (n=natural number). A further possibility of allocating x to the xᵢ is the following: the maximum bandwidth available via a tunnel from A to B is selected for x₁; the bandwidth available on the corresponding links is then reduced by x₁; on the basis of the reduced available bandwidths, the maximum bandwidth that is then still available via a tunnel from A to B is selected for x₂; the bandwidth available on the corresponding links is then reduced by x₂; etc.

A significant advantage of the last-mentioned method lies in the fact that a descending sequence of numbers x₁, x₂, . . . , xₙ, is determined, where none of the xᵢ is dependent on the choice of n. This means that it is not necessary to recalculate all the xᵢ (i.e. all the tunnels) if n is changed and the paths will be used to their optimal capacity.

To avoid a very large number of tunnels being created from one logical connection path, the maximum number N of tunnels should be configurable as a parameter. In this way it is also ensured that the ingress node only uses a limited amount of time (and hence capacity) in the search for a possible subdivision of the requested path into tunnels. Thus, with the above-mentioned second possibility too, a simple abort criterion is produced for determining the numbers x₁, x₂, . . . , xₙ.

A hash algorithm should be used for allocating the data traffic from A to B to the individual tunnels. This should ensure that the load balancing is carried out at the level of flows and individual data packets of the same flow do not get sent via different tunnels, since otherwise packet transpositions can result due to different propagation delays. This can be ensured by including in the hash algorithm only data that does not change in the course of a flow (for example IP addresses, port numbers, etc.). In the event that the xᵢ were not selected as identical, a corresponding non-uniform distribution must be implemented.

If alternate paths are to be set up only from end to end, then the implementation of a path by a plurality of tunnels does not affect the alternate path finding. The alternate path or paths from A to B can also be implemented in the form of a plurality of tunnels. However, if alternate path switching operations are to be performed locally (as in the case of MPLS Fast ReRoute for example), then each tunnel must be taken into account individually and corresponding local alternate paths are to be used for all of the tunnels.

With the conventional data transmission methods it is unlikely, in conditions of heavy network utilization, that it will be possible to set up a new logical connection path with a high bandwidth requirement over just one physical data transmission path. The proposed mechanism can, however, support the setting up of a corresponding path and reduces the number of rejected reservations by balancing the load. This leads to a better utilization of available network resources, thereby avoiding an immediate expansion of link capacities and hence saving costs.

The system also includes permanent or removable storage, such as magnetic and optical discs, RAM, ROM, etc. on which the process and data structures of the embodiments can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for setting up a logical end-to-end connection path of a selectable first bandwidth from a source network node to a destination network node in a connection-oriented packet-switched communications network, comprising:
determining a plurality of physical end-to-end data transmission paths from the source network node to the destination network node with, in each case, available second bandwidths in accordance with the logical connection path that is to be set up;
selecting one or more of the determined physical data transmission paths in such away that the second bandwidths of the physical data transmission paths correspond in total at least to the first bandwidth of the logical connection path; and
signaling the at least one selected physical data transmission path to set up the logical connection path.

12. The method as claimed in claim 11, wherein the physical data transmission paths are selected successively according to highest available second bandwidth in each case.

13. The method as claimed in claim 11, wherein the first bandwidth of the logical connection path is divided by a selectable divider to determine a third bandwidth and a number of physical data transmission paths corresponding to the result of the divider is selected subject to the condition that their second bandwidth corresponds at least to the third bandwidth.

14. The method as claimed in one of claim 11, wherein a selectable maximum number of physical data transmission paths is signaled.

15. A method for transmitting data packets from a source network node to a destination network node of a connection-oriented packet-switched communications network as claimed in claim 11, further comprising:
setting up a logical end-to-end connection path from the source network node to the destination network node according to the signaling;
allocating data packets to be transmitted from the source network node to the signaled physical data transmission paths in accordance with the second bandwidths and forwarding the data packets to the destination network node.

16. The method as claimed in claim 15, wherein the data packets are distributed over the signaled physical data transmission paths using a hash algorithm.

17. A connection-oriented packet-switched communications network comprising a plurality of network nodes connected to one another via respective data links, in which communications network the network nodes are suitably configured for performing a method as claimed in claim 11.

18. A machine-readable program code for a network node of a connection-oriented packet-switched communications network as claimed in claim 17, the code containing control commands that cause the network node to perform a method as claimed in claim 11.

19. A network node of a connection-oriented packet-switched communications network, in which network node machine-readable program code as claimed in claim 18 is executed.

20. A storage medium on which is stored a machine-readable program code as claimed in claim 18.
